(19) United States
(12) Patent Application Publication
(10) Pub. No.: US 2005/0246914 A1
(43) Pub. Date: Nov. 10, 2005

(54) Adjustable bolt hole marker

(76) Inventor: Gabriel I. Perea, San Diego, CA (US)

Correspondence Address: David B. Waller;David B. Waller & Associates, Suite 214, 5677 Oberlin Drive, San Diego, CA, 92121, US

(21) Appl. No.: 11/120,516

(22) Filed: May 2, 2005

Related U.S. Application Data
(60) Provisional application No. 60/567,839, filed on May 4, 2004.

(51) Int. Cl. G01B 3/14

(52) U.S. Cl. 33/562

(57) ABSTRACT

A bolt hole marking device comprising a tubular body having a top and a bottom, an elongated base plate having a upper surface, a rod fitted within the tubular body having a gripping end and a pointed end and at least two discs rotatably mounted on the base plate one on each end. The upper surface of the base plate having two ends, at least two pegs positioned, one on each end and extending perpendicular to the base plate and at least one aperture at a predetermined distance between the pegs. The bottom of the tubular body is positioned over the aperture and affixed to the base plate. The pointed end of the rod may be extended beyond the bottom of the tubular body. The at least two discs having a plurality of recesses of different radii formed therein arranged about the periphery of the discs and a plurality of apertures able to receive the pegs for fixing the discs in position on the base plate.

### REFERENCE TO RELATED APPLICATIONS

This application is a continuation-in-part application of provisional patent application Ser. No. 60/567,839 filed 4 Mar. 2004.

### TECHNICAL FIELD

The present invention relates to building, constructing and fabricating structures, more specifically the present invention is utilized to locate and mark bolt hole positions in framing members to be affixed to bolts set in structural foundations.

### BACKGROUND OF THE INVENTION

A conventional technique used in construction of residential and commercial building involves concrete foundations made of poured cement with threaded bolts being set upright in the edges of the wet cement for subsequently securing the base plate of the frame structure. Historically the base plate was marked for drilling by placing the base plate over the bolts and impacting the base plate with a hammer to leave the impression of the bolt ends in the base plate. The problem with this approach was that the shafts of the bolts extending from the concrete slab were often times not perpendicular, which resulted in improper alignment of the holes to receive the bolts. Consequently the individual performing this function would have to expend additional time in straightening the bolts and hammering the base plate into position. Often times this resulted in splitting the base plate or dislodging the bolt from the concrete foundation.

In an effort to avoid these shortcomings the individual would, on occasion, drill holes that were larger than the bolt diameters. The major problem with this approach was that the base plate could no longer be secured tightly to the foundation, lessening its stability and strength thereby effecting the frame structure erected above the floor.

Bolt hole locating and marking tools have been developed and used in the industry that have resolved many of the problems discussed above. For example, U.S. Pat. No. 4,363,173 describes a bolt hole locating and marking tool comprising an elongated tubular guide member having upper and lower ends, a generally flat rectangular base member affixed to the lower end of the elongated tubular guide member, a hand actuated inertial impact member having a point on one end able to be inserted into the elongated tubular guide member such that the pointed end is located on the lower end of the tubular member, a coil spring affixed to the upper end of the tubular guide member and able to contact the hand actuated inertial impact member to support the impact member preventing the pointed end from protruding beyond the lower end of the tubular guide member, a semi circular cut out at each end of the base member for receiving a bolt and a clamping means for affixing the base member to the lower end of the tubular member. In order for the device to accurately establish a marking the radius of the semicircular cut out on the elongated generally flat rectangular base member must be the same radius of the bolts secured in the concrete slab. Unfortunately, recent building codes in some states require a number of different sized diameter bolts to be affixed within the concrete slab to secure the structure above where seismic activity is a concern, such as California. Consequently, the device according to U.S. Pat. No. 4,363,173 would not be beneficial in areas where building codes prescribe a number of different diameter size bolts for securing a structure to a foundation.

Another device described in U.S. Pat. no. 4,520,571 is a bolt hole marker comprising a handle portion, a measuring arm slidably received within the handle, a marking member carried on the measuring arm and a depending flange affixed to the handle portion for aligning the marker. This device has the same disadvantage as the device of U.S. Pat. No. 4,363,173. In addition, the device is a small compact device to be used in a crouched position. Marking a large number of bolt holes along a base plate while bending over can result in back, shoulder and neck discomfort.

Consequently, there is a need in the industry for a device that can accurately mark bolt holes in a base plate where a wide variety of bolt diameters maybe required by building codes that vary from location to location. In addition, it would be beneficial to be able to operate the bolt hole marker in an ergonomic and comfortable position, such as standing.

### SUMMARY OF THE INVENTION

One aspect of the present invention provides a bolt hole marking device comprising a tubular body having a top and a bottom; an elongated base plate having a upper surface, the upper surface having two ends, at least two pegs positioned on the upper surface, one on each end and extending perpendicular to the base plate and at least one aperture at a predetermined distance between the pegs, said bottom of the tubular body positioned over the aperture and affixed to the base plate; a rod slidably fitted within the tubular body having a gripping end and a pointed end, the pointed end extending beyond the bottom of the elongated tubular body; and at least two discs rotatably mounted on the upper surface of the base plate one on each end the at least two discs having a plurality of recesses of different radii formed therein arranged about the periphery of the discs and a plurality of apertures able to receive the pegs for fixing the discs in position on the base plate.

### DESCRIPTION OF THE FIGURES

FIG. 1: Is a diagrammatic representation of two possible configurations of discs that may be utilized with the present invention, (A) a top view of a disc having four different sized recesses for receiving a bolt, (B) a bottom view of the disc in (A) showing the apertures for receiving the pegs and (C) a top side view of the disc; (D) a side view of the disc; (E) a bottom side view of the disc; and (F) a disc having six different recesses for receiving a bolt.

FIG. 2: Is a diagrammatic representation showing one method for rotatably affixing the discs to the base plate.

FIG. 3: Is a perspective view of the device shown in FIG. 2.

### DETAILED DESCRIPTION

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail.

The term “affixed” as used herein refers to a means for securely retaining one element of the device to another element by a variety of means known to one skilled in the art, such as, for example brazing, welding, soldering or adhesive.

The present invention contemplates a variety of constructions for the bolt hole marking device. Preferably one contemplated construction comprises a tubular body having a top and a bottom; an elongated base plate having a upper surface, the upper surface having two ends, at least two pegs positioned on the upper surface, one on each end and extending perpendicular to the base plate and at least one aperture at a predetermined distance between the pegs, the bottom of the tubular body is positioned over the aperture and affixed to the base plate; a rod slidably fitted within the tubular body having a gripping end and a pointed end, the pointed end extending beyond the bottom of the tubular body; and at least two discs rotatably mounted on the base plate one on each end of each disc having a plurality of recesses of different radii formed therein arranged about the periphery and a plurality of apertures able to receive the pegs for fixing the discs in position on the base plate.

Tubular Body

The tubular body 12 is about 2½ to 4 feet in height, most preferably about 3 feet in height and constructed of a rigid material such as for example metal and may be prepared from tubular stock material having an internal diameter of from about ¼ to about ½ inch preferably about ⅜ inch. The thickness of the tubing may vary and will depend on the overall desired weight of the device and resistance to bending. Preferably the tubular stock is from not less than about 3/32 to not more than about ⅛ inch. The tubular body is preferably made of metal or high density polymer. If the tubular body 12 is made of metal it may be treated to increase strength if desired such as for example heating and quickly cooling the metal. The internal diameter is such that it may accept a solid rod 18 of a length greater than the tubular body 12 with sufficient room to allow the rod 18 to move easily in and out of the tubular body 12 in a generally linear path with limited side to side motion. The tubular body 12 maybe made of circular, octagonal, square or triangular stock. Preferably it is made of cylindrical stock material.

Elongated Base Plate

The elongated base plate 14 is generally rectangular or oval in shape having a length of not less than about 6 inches and not more than about 10 inches. Preferably the length is about 8 inches. The width may vary from not less than about 1 inch and not more than about 3 inches. Preferably the width is about 1-½ inches. The thickness of the elongated base plate 14 must be such that it resists bending, consequently the thickness is not less than about ⅛ inch and not more than about ¼ inch. Preferably the thickness is 3/16 inch. It is preferable that the base plate be made of the same material as the tubular body 12.

On either end of the elongated base plate 14 are means for rotatably attaching the discs 16 for receiving the bolt. A variety of means known to those skilled in the art may be used for affixing the discs 16 rotatbly to the ends of the elongated base plate 14. In one embodiment an aperture 34 is provided for affixing the discs 16 by bolt, pin or rivet 22. The diameter of the aperture 34 may vary depending on strength desired for maintaining the discs 16 on the elongated base plate 14. Preferably it is not less than about ⅛ inch and not more than about ¼ inch. Most preferably the diameter is about 3/16 inch. The apertures 34 are provided in the elongated base plate 14 at an angle perpendicular to the upper surface of the elongated base plate 14. Placement of the apertures 34 on the elongated base plate 14 will depend on the diameter of the discs 16. In one configuration when the discs 16 are about 3 inches in diameter and the base plate and at least two discs rotatably mounted on the elongated base plate one on each end 14 is approximately 8 inches in length and about 1.5 inches in width the 3/16inch aperture 34 are drilled through the elongated base plate 14 approximately 1 inch in from the end to center from each end and approximately ¾ inch to center from width on each end.

In another configuration short cylindrical pins may be affixed to the upper surface of the elongated base plate on which the discs may be mounted and secured. For example, the cylindrical pin may have a top and bottom ends wherein the bottom end is affixed to the upper surface of the base plate in the desired location and the top end may be able to receive a cap maintaining the disc on the cylindrical pin.

One or more pegs 20 may be provided in the upper surface of the elongated base plate 14 for each disc 16 to anchor the discs 16 in the desired position. In one embodiment each end of the elongated base plate 14 is provided with two pegs 20 extending upward from and perpendicular to the top of the elongated base plate 14. Preferably when two pegs 20 are used to secure each disc 16 they are provided in line and equidistant from the disc attachment aperture 34. The pegs 20 are constructed of a generally rigid material such as metal and are generally prepared from stock rod material that may have a variety of shapes such as triangular, rectangular, square or cylindrical. Preferably the pegs 20 are made of cylindrical stock rod material having a diameter not less than 1/16 inch and not more than ¼ inch, preferably about ⅛ inch in diameter. The pegs may be adhered to the elongated base plate 14 by brazing, welding, soldering or adhesive. Alternatively they may be fastened in place such as by screw threads. If anchored by screw threads peg holes may be drilled so that they are positioned on either side of the aperture 34 generally separated by approximately 180 degrees on each side. If the peg holes and apertures 34 are in line lengthwise along the elongated base plate 14 then the peg holes are at about ⅜ inch to center of hole and about another 1⅝″ inches to center of hole from the ends and about ¾ inch from the width of the elongated base plate 14 to the center of the holes.

The length of the peg 20 will depend one the thickness of the discs 16. The length of the peg 20 is preferably sufficient to extend a majority of the thickness of the disc 16 but may exceed that thickness if desired. So for example, if the disc 16 is ⅛ inch thick and the thickness of the elongated base plate 14 is 3/16 inch thick the peg 20 could be not less than ¼ to about ⅜ inch. Preferably the pegs 20 are made of the same material as the elongated base plate 14.

The pegs 20 may be secured in place by a variety of methods known to those skilled in the art such as for example by welding, brazing or soldering. The pegs 20 are preferably positioned flush with the bottom of the elongated base plate 14 and will extend above the top approximately 3/16.

An aperture 32 ⅜″ (+/−) in diameter may be drilled (pulling from one side of length) 3″ (+/−) to center of holes. 5″ (+/−) will be the measurement from center of aperture to the other side of length. The elongated base plate 14 and tubular body 12 will be joined together by welding the hollow portion of the tubular body 12 over the ⅜″ (+/−) aperture 32 of the elongated base plate 14 so that the rod 18 will slide through the tubular body 12 and elongated base plate 14 with ease and without obstruction. Preferably the internal diameter of the tubular body 12 and the external diameter of the aperture 32 in the elongated base plate 14 are the same dimensions.

Rod

The rod 18 is longer than the tubular body 12 by an amount sufficient to provide a handle 26 for gripping near the top of the tubular body 12 and an amount necessary to allow the point 28 on the other end of the rod 18 to leave a noticeable impression in the beam being marked. Consequently if the tubular body 12 is 3 feet in length the rod 18 might be not less than 39 inches and not more than about 48 inches. Preferably the length of the rod 18 is about 41 inches in length when the tubular body 12 is about 36 inches long. Preferably the rod 18 is made of solid stock having an external surface that is similar or identical to the interior surface of the tubular body 12. Preferably the rod 18 is made of the same material as the tubular body 12.

The diameter of the rod 18 is sufficient to allow it to be inserted into and slide easily within the tubular body 12 with a minimal amount of side to side movement. For example, if the internal diameter of the tubular body 12 is about ⅜ inch than the diameter of the rod 18 could be from not less than ¼ inch to not more than about 5/16 inch.

One end of the rod 18 is preferably affixed with a handle 26 for ease of gripping to draw the rod 18 upward and for thrusting the rod 18 downward within the tubular body 12. The other end of the rod is sharpened to a point 28 sufficient to cause a noticeable mark when impacting a beam to be marked.

Discs

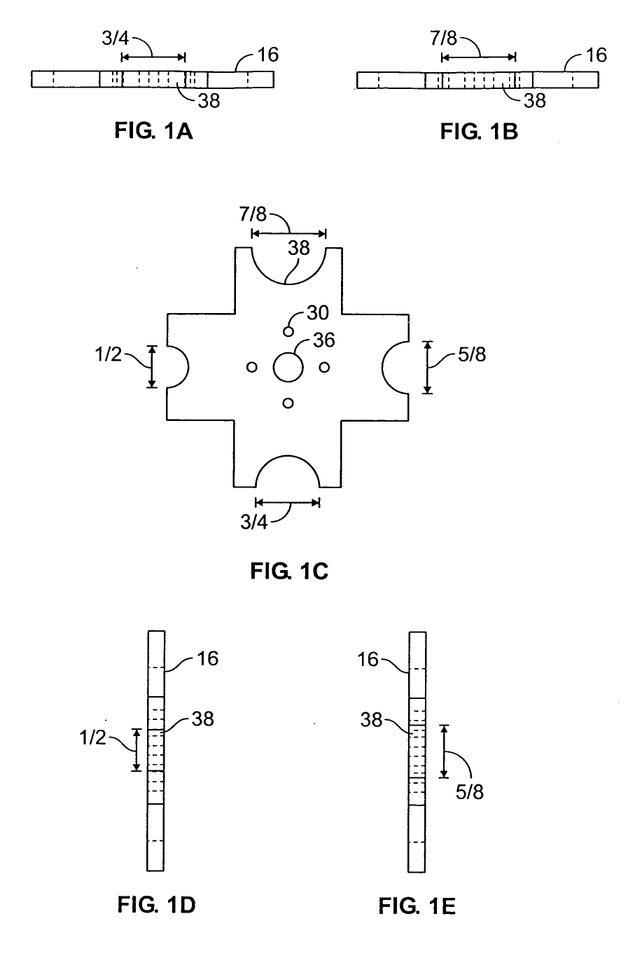

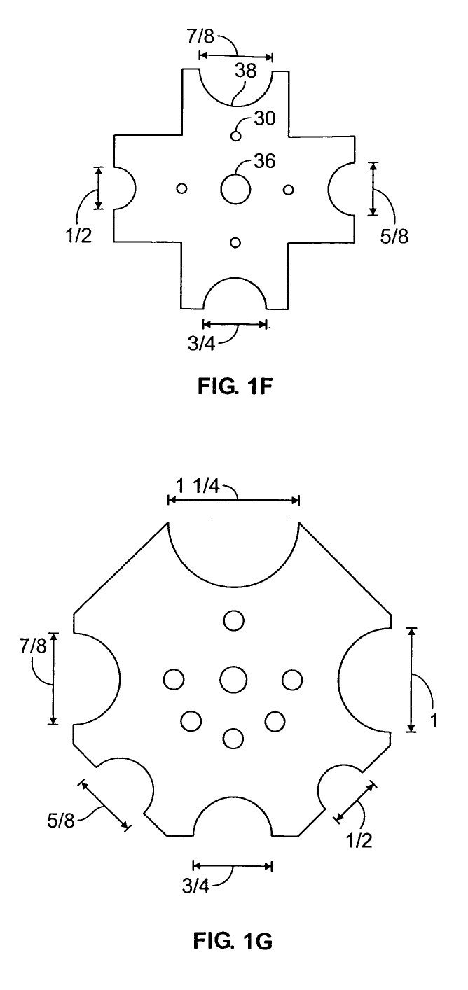

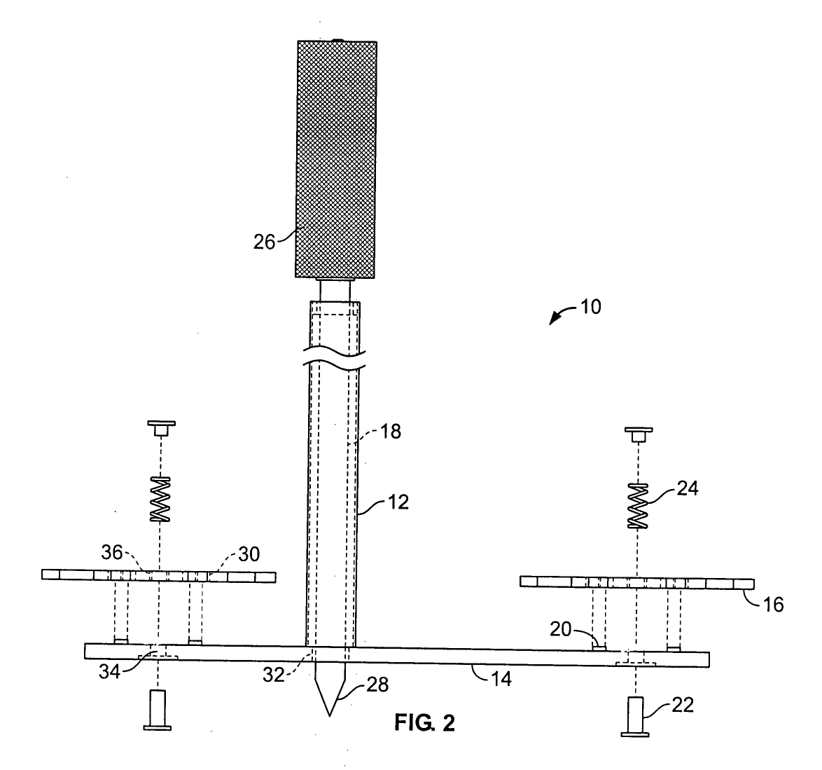

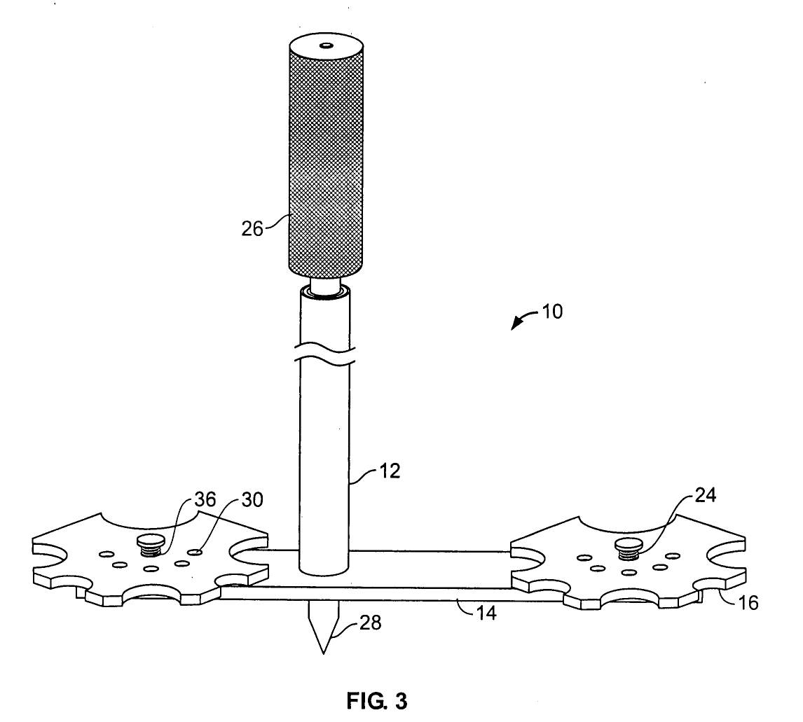

The discs 16 comprise a plurality of different sized recesses 16 of different radii formed along its perimeter to receive a variety of different diameter sized bolts. The discs 16 are generally from about 2 to 4 inches in diameter or 2″ by 2″ or 4″ by 4″ square, preferably about 3 inches in diameter or about 3″ by 3″ square. The discs 16 maybe from about 3/32 to about 1/4 inch in thickness, preferably about ⅛ inch thick. The discs 16 may be provided in a variety of shapes, examples of two potential shapes are shown in FIG. 1. If a hexagon shape the disc 16 will have different semicircular shaped notches on each face having radii ranging from about ½ inch to about 1¼ inch. Another disc 16 such as that shown in FIG. 1 (C) may be constructed with four perimeter edges notched with different semicircular shapes 38 ranging in radii length of about ½ inch to about ⅞ inch. Correspondingly a circular shaped disc 16 may also be utilized in a similar manner. Each disc 16 will preferably have an aperture 36 at its center having a similar diameter as the elongated base plate aperture 34. For example if the elongated base plate 14 has an aperture 34 on each end of 3/16 inch diameter the disc 16 to be affixed at either of those locations will have a center aperture of 3/16 inch diameter.

The apertures to receive the pegs 30 for securing the discs 16 in position during use will vary depending on the location of the pegs 20 on the upper surface of the elongated base plate 14 and their diameter. In one preferred configuration the apertures 30 for securing the discs 16 may be drilled through the discs 16 at about ⅞ inch and about 1⅛ inch from the outer perimeter of the disc 16.

The discs 16 are preferably made of durable material that resists impact during use such as for example metal or high-density polymer. When the discs 16 are rotatably attached to the elongated base plate 14, springs 24 maybe used to apply force between the rivet head and the top of the disc 16 drawing the pegs 20 on the upper surface of the elongated base plate 14 into the peg apertures 30 on the discs 16, locking the disc 16 in place. Springs 24 also allow the user to easily change the notch diameter 38 during use. This may be done by lifting the disk 16 so that it is free of the pegs 20, rotating the disc 16 to the desired notch diameter 38 and releasing the disc 16 allowing it to snap into place and onto the securing pegs 20.

Assembly

The tubular body 12 may be affixed to the elongated base plate 14 by a variety of methods known to those skilled in the art such as by soldering, brazing, welding or adhesive making sure that the aperture 32 is not obstructed. The discs 16 may be affixed rotatbly to the top surface of the elongated base plate 14 by a variety of methods known to those skilled in the art including for example the use of a rivet 22. In this example, a rivet 22 of about 1 inch having a diameter just less than the aperture 34 of the elongated base 14 is inserted through the aperture 34 of the base plate 14 from the bottom, then through the aperture of disc 36, then through the center of a spring 24 having a diameter just greater than the diameter of the rivet 22 and a length of about 1 inch and then to the rivet head. The rivet 22 is then affixed to the rivet head securing all pieces in place.

Use

In use the base plate end having the desired predetermined distance is selected for the particular application. The disc is rotated to the appropriate radii for the size bolt being measured assuring that the pegs are firmly positioned in the peg holes locking the disc in position. The board or beam to be marked is placed in position along side the bolts on which the beam is to be affixed once the bolt positions are marked and the holes of the appropriate size are drilled. The selected recess in the perimeter of the disc is brought into contact with the body of the bolt with the elongated base plate perpendicular to the length of the beam being marked. The handle of the upper end of the rod is grasped firmly. The rod is drawn upward a desired distance and then brought down so that the pointed end of the rod impacts the beam making a noticeable mark. Once marked the bolts holes may be drilled in the beam based on the markings thus provided. The beam can then be easily fitted over the bolts in the concrete slab and secured to the foundation.

1. A bolt hole marking device comprising: a tubular body having a top and a bottom; an elongated base plate having a upper surface, said upper surface having two ends, at least two pegs positioned on said upper surface, at least one peg on each end and extending perpendicular to said base plate and at least one aperture at a predetermined distance between said pegs, said bottom of said tubular body positioned over said aperture and affixed to said base plate; a rod slidably fitted within said tubular body having a gripping end and a pointed end, said pointed end extending beyond said bottom of said elongated tubular body; and at least two discs rotatably mounted on said upper surface of said base plate one on each end, said at least two discs having a plurality of recesses of different radii formed therein arranged about the periphery of said discs and a plurality of apertures able to receive said pegs for fixing said discs in position on said base plate.

2. A bolt hole marking device according to claim 1 wherein said discs are rotatably mounted by a rivet said rivet having a head and a base.

3. A bolt hole marking device according to claim 2 further comprising a spring positioned on said rivet between said rivet head and said disc on said upper surface of said elongated base plate.

4. A bolt hole marking device according to claim 1 wherein said disc is round in shape, square in shape or octagonal in shape.
